(19) United States
(12) Patent Application Publication
(10) Pub. No.: US 2013/0328501 A1
(43) Pub. Date: Dec. 12, 2013

(54) CONTROL DEVICE AND ILLUMINATION DEVICE

(71) Applicant: KABUSHIKI KAISHA TOSHIBA, Tokyo (JP)

(72) Inventors: Yusuke MORIUCHI, Kanagawa (JP); Junya TAKAKURA, Tokyo (JP); Kanako SAITO, Kanagawa (JP); Yoshie IMAI, Tokyo (JP); Toshimitsu KANEKO, Kanagawa (JP)

(21) Appl. No.: 13/911,583

(22) Filed: Jun. 6, 2013

(30) Foreign Application Priority Data
Jun. 8, 2012 (JP) 2012-130882

(51) Int. Cl. H05B 37/02

(52) U.S. Cl. CPC H05B 37/02
USPC 315/294

(57) ABSTRACT

According to an embodiment, a control device includes a first calculator and a second calculator. The first calculator is configured to calculate a wavelength of light to be emitted from a light source whose emission intensity is controllable and which has at least one light emitting element at predetermined time intervals in a manner that adjusts the wavelength by a predetermined amount of change within a range of a first wavelength of light to be emitted at a start of adjustment to a second wavelength of light to be emitted at an end of the adjustment, the calculated wavelength being set as a third wavelength. The second calculator is configured to calculate an emission intensity of the light emitting element at the third wavelength.

### CROSS-REFERENCE TO RELATED APPLICATION

This application is based upon and claims the benefit of priority from Japanese Patent Application No. 2012-130882, filed on Jun. 8, 2012; the entire contents of which are incorporated herein by reference.

### FIELD

Embodiments described herein relate generally to a control device and an illumination device.

### BACKGROUND

Multicolor illumination using a light source having a plurality of light emitting elements capable of outputting light with various wavelengths to adjust the color of the illumination to an arbitrary color has been used in related art. An example of effects produced by adjusting the color of illumination is that the level of arousal of a user is improved by being exposed to light containing many long-wavelength components around 460 nm, and adjustment of illumination colors may have various influences on users.

There is, however, a disadvantage that multicolor illumination described above, may make users uncomfortable in some cases. Specifically, the spectral distribution of the multicolor illumination is different from that of white light illumination or illumination equivalent to white light used daily by a user or that of illumination previously used or used in different scenes by a user, which may make the user uncomfortable when the multicolor illumination is turned on.

### BRIEF DESCRIPTION OF THE DRAWINGS

FIG. 1 is a block diagram illustrating a control device according to a first embodiment;

FIG. 2 is a diagram illustrating selection of a first wavelength according to the first embodiment;

FIG. 3 is a diagram illustrating selection of a second wavelength according to the first embodiment;

FIG. 4 is a diagram illustrating arrangement of light emitting elements of a light source;

FIG. 5 is a flowchart illustrating the overall process according to the first embodiment;

FIG. 6 is a block diagram illustrating a control device according to a second embodiment;

FIG. 7 is a flowchart illustrating the overall process according to the second embodiment;

FIG. 8 is a block diagram illustrating a control device according to a third embodiment;

FIG. 9 is a block diagram illustrating a first calculator according to the third embodiment;

FIG. 10 is a graph of a changed initial wavelength according to the third embodiment;

FIG. 11 is a flowchart illustrating the overall process according to the third embodiment;

FIGS. 12A and 12B are diagrams of prompting a user to set bedtime; and

FIG. 13 is a block diagram illustrating an illumination device.

### DETAILED DESCRIPTION

According to an embodiment, a control device includes a first calculator and a second calculator. The first calculator is configured to calculate a wavelength of light to be emitted from a light source whose emission intensity is controllable and which has at least one light emitting element at predetermined time intervals in a manner that adjusts the wavelength by a predetermined amount of change within a range of a first wavelength of light to be emitted at a start of adjustment to a second wavelength of light to be emitted at an end of the adjustment, the calculated wavelength being set as a third wavelength. The second calculator is configured to calculate an emission intensity of the light emitting element for reproducing the third wavelength.

### First Embodiment

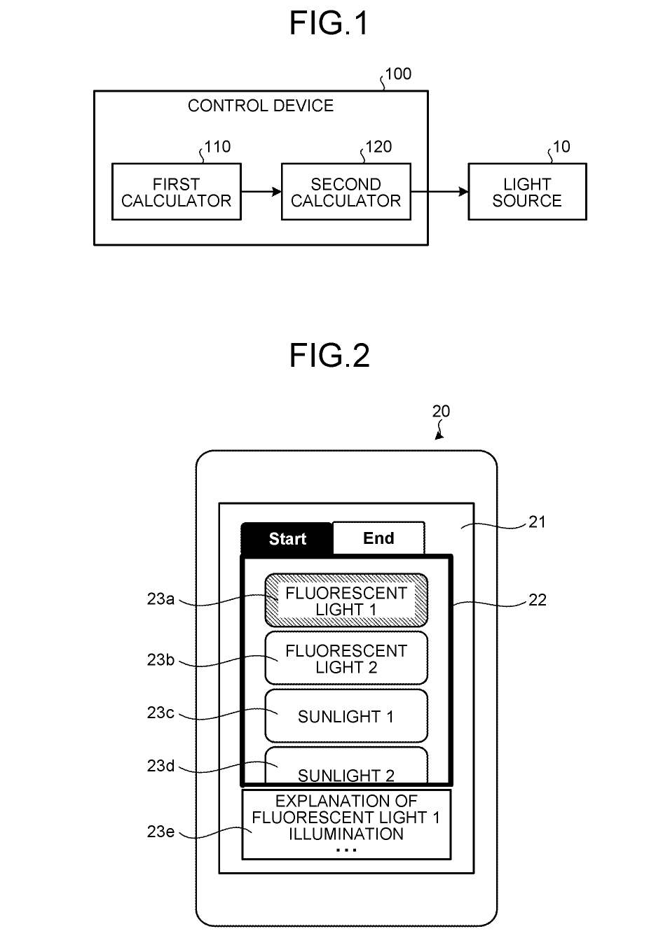

FIG. 1 is a block diagram illustrating an exemplary configuration of a control device 100 according to a first embodiment. As illustrated in FIG. 1, the control device 100 includes a first calculator 110 and a second calculator 120. The control device 100 is a device that is connected to a light source 10 whose emission intensity is controllable and which has at least one light emitting element, and that adjusts the color of output light emitted from the light source 10. For example, the control device 100 is an integrated circuit such as an application specific integrated circuit (ASIC) or a field programmable gate array (FPGA) or an electronic circuit such as a central processing unit (CPU) or a micro processing unit (MPU).

The first calculator 110 obtains a first wavelength representing a wavelength of output light emitted at the start of adjustment of the light source 10 and a second wavelength representing a wavelength of output light emitted at the end of adjustment of the light source 10 from a predetermined memory.

Such a first wavelength is employed at the start of adjustment of the color of output light from the light source 10 (at the start of illumination), and has a spectral distribution of color that is less uncomfortable for users. As the spectral distribution of the first wavelength, the spectral distribution of standard white light illumination or illumination equivalent to white light, the spectral distribution of illumination in an environment that has been used by the user until now, or the spectral distribution of illumination in a next room, for example, is used. Examples of standard illumination include a standard illuminant and a supplementary illuminant as defined by Japanese Industrial Standards JIS Z 8720 and the spectral distribution of a typical fluorescent lamp as defined by Japanese Industrial Standards JIS Z 8719; and these may be used for the first wavelength. Furthermore, examples of standard illumination may include a CIE standard illuminant and a supplementary standard illuminant as defined by ISO 23603: 2005/CIE S 012/E: 2004 and the spectral distribution of a typical fluorescent lamp as defined by Publication CIE No. 15.2 (1986) Colorimetry, 2nd edition; and these may also be used for the first wavelength.

The second wavelength is employed when adjustment of the color of output light from the light source 10 is terminated and has a spectral distribution producing a color and an effect desired by the user. As the spectral distribution of the second wavelength, the spectral distribution of warm colors for making the user feel at ease, the spectral distribution of green colors for reproducing light that is hardly transmitted by eyelids at night, or the spectral distribution of blue lights for reminding the user of an aquarium, for example, may be used. Preferably, combination of such first wavelength and second wavelength can be arbitrarily selected by the user.

FIG. 2 is a diagram illustrating an example of selection of the first wavelength according to the first embodiment. As illustrated in FIG. 2, selection of the first wavelength is performed by using a remote controller 20 or a screen or buttons for selection provided on an illumination device. Such a remote controller 20 is equipped with a screen 21 such as a touch panel display. A tab “Start” associated with selection of the first wavelength and a tab “End” associated with selection of the second wavelength are displayed on the screen 21. Specifically, the tab “Start” means selection of the color of output light output from the light source 10 at the start of adjustment. Similarly, the tab “End” means selection of the color of output light output from the light source 10 at the end of adjustment. In FIG. 2 illustrating an example of selection of the first wavelength, a state in which the tab “Start” is selected is presented.

In addition, the screen 21 has a display area 22 that can be scrolled by flicking and in which an item can be selected by tapping. In this display area 22, candidates of the color of output light from the light source 10 at the start of adjustment are displayed. For example, a candidate 23a is “fluorescent light 1”, a candidate 23b is “fluorescent light 2”, a candidate 23c is “sunlight 1” and a candidate 23d is “sunlight 2”. In the example of FIG. 2, the candidate 23a “fluorescent light 1” is selected among these candidates. On the screen 21, an explanation field 23e for displaying explanation of the selected candidate is also provided. In the example of FIG. 2, the explanation of the candidate 23a “fluorescent light 1” that is selected is displayed.

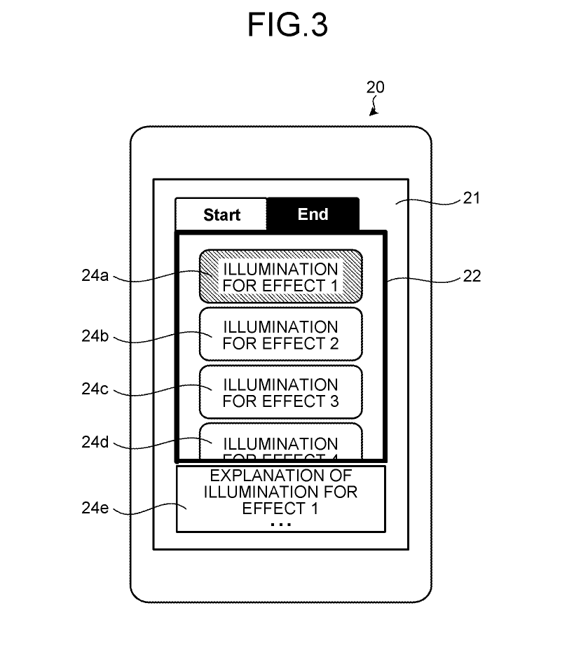

FIG. 3 is a diagram illustrating an example of selection of the second wavelength according to the first embodiment. As illustrated in FIG. 3, selection of the second wavelength is performed by using the remote controller 20 similarly to the first wavelength. In FIG. 3 illustrating an example of selection of the second wavelength, a state in which the tab “End” is selected is presented. In the display area 22, candidates of the color of output light from the light source 10 at the end of adjustment are displayed. For example, a candidate 24a is “illumination for effect 1”, a candidate 24b is “illumination for effect 2”, a candidate 24c is “illumination for effect 3” and a candidate 24d is “illumination for effect 4”. In the example of FIG. 3, the candidate 24a “illumination for effect 1” is selected among these candidates. On the screen 21, an explanation field 24e for displaying explanation of the selected candidate is also provided. In the example of FIG. 3, the explanation of the candidate 24a “illumination for effect 1” that is selected is displayed.

The colors of output light from the light source 10 at the start of adjustment and at the end of adjustment selected in this manner are stored in a predetermined memory. The first calculator 110 then calculates a third wavelength representing a wavelength adjusted by a predetermined amount of change at predetermined time intervals within a range of the first wavelength to the second wavelength, and outputs the calculated third wavelength to the second calculator 120. The unit time is a time of one second or shorter, for example.

The predetermined amount of change represents an amount of change of the color of illumination per unit time or an amount of change of the color of an object illuminated. When the predetermined amount of change represents the amount of change of the color of an object illuminated, it is preferable that the predetermined amount of change be the amount of change of the color of an object to which the user pays attention. If, however, an object to which the user pays attention cannot be determined, the predetermined amount of change may be determined on the assumption that the object to which attention is paid is a perfectly diffusing white object.

For example, the amount of change of the color of an object can be expressed by using a uniform color space such as a U*V*W* color space or a L*a*b* color space defined by International Commission on Illumination (CIE) or a color difference in CIECAM02 color space taking adaptation into account. For example, when a color difference ΔE*_{ab} in L*a*b* color space is used, the predetermined amount of change can be expressed as V [ΔE*_{ab}/s]. For the predetermined amount of change V in this case, it is desired that a value that does not allow the change in the color of illumination to be recognized even if the illumination is continuously looked straight at be employed. For example, the predetermined amount of change is a value that satisfies V<0.433. In other words, the first calculator 110 sets the first wavelength as the color of output light from the light source 10 at the start of adjustment, and sequentially calculates the third wavelength by adjustment with the predetermined amount of change of V<0.433 per unit time of one second or shorter until the third wavelength becomes equal to the second wavelength.

Here, a method for calculating the third wavelength will be described. As described above, the spectral distribution of the third wavelength is updated on the basis of the amount of change of the color of illumination per unit time or the amount of change of the color of an object illuminated. First, a method for calculating the color of an object illuminated will be described. When the L*a*b* color space is used as a uniform color space, tristimulus values X, Y, Z of the object is obtained from the spectral distribution of the illumination and the spectral distribution of the object. The tristimulus values X, Y, Z of the object can be expressed by Equation (1) using the spectral distribution P(λ) of the illumination, the spectral reflectivity R(λ) of the object and color matching functions. The integration in Equation (1) is calculated in a range of 380 to 720 nm that is a wavelength region of visible light.

$$[ \begin{matrix}X \\ Y \\ Z\end{matrix} ] = k \int visR ( λ ) \cdot P ( λ ) \cdot [ \begin{matrix}\overline{x} ( λ ) \\ \overline{y} ( λ ) \\ \overline{z} ( λ )\end{matrix} ] d λ \qquad ( 1 )$$

where k=100/∫visP(λ)· y̅(λ)dλ, and x̅(λ), y̅(λ) and z̅(λ) are color matching functions.

Next, the tristimulus values X, Y, Z calculated from Equation (1) are converted to chromaticity coordinates (L*a*b*) in the L*a*b* color space. For the conversion to a uniform color space, a preset transformation formula defined by International Commission on Illumination (CIE) may be used, and a Euclidean distance of the obtained L*a*b* color space is defined as a color difference ΔE*_{ab}. Specifically, when the color of the object illuminated with an initial wavelength Pₛₜₐᵣₜ(λ) is represented by (L*ₛₜₐᵣₜ, a*ₛₜₐᵣₜ, b*ₛₜₐᵣₜ) and the color of the object illuminated with the second wavelength P_{target}(λ) is represented by (L*_{target}, a*_{target}, b*_{target}), the change ΔE*_{ab}_{ₛ₋ₜ} in the color of the object between the start of adjustment and the end of adjustment can be expressed by Equation (2). Note that L* is preferably constant although it is within an error tolerance level. In addition, the initial wavelength is the first wavelength in the first embodiment.

$$Δ {E}_{abs - t}^{*} = \sqrt{{( {L}_{start}^{*} - {L}_{target}^{*} )}^{2} + {( {a}_{start}^{*} - {a}_{target}^{*} )}^{2} + {( {b}_{start}^{*} - {b}_{target}^{*} )}^{2}} \qquad ( 2 )$$

Note that the predetermined amount of change is represented by V [ΔE*_{ab}/s]. Since the predetermined amount of change is an amount of change in the color of the object per unit time, the time T [s] required from the start of adjustment to the end thereof can be expressed as T=ΔE*_{ab}_{ₛ₋ₜ}/V by using the color difference ΔE*_{ab}_{ₛ₋ₜ} and the predetermined amount of change V. When the spectral distribution of illumination t seconds after the start of adjustment is represented by Pₜ(λ), Pₜ(λ) can be expressed by Equation (3) by using the initial wavelength Pₛₜₐᵣₜ(λ) and the second wavelength P_{target}(λ).

$${P}_{t} ( λ ) = ( 1 - \frac{t}{T} ) {P}_{start} ( λ ) + ( \frac{t}{T} ) {P}_{target} ( λ ) \qquad ( 3 )$$

Accordingly, the first calculator 110 outputs the obtained spectral distribution Pₜ(λ) as the third wavelength t seconds after the start of adjustment to the second calculator 120. In other words, the first calculator 110 updates the third wavelength by an amount of change that is not perceived by the user until the color that is not uncomfortable for the user is changed to a color that is desired by the user.

The second calculator 120 calculates the emission intensity of each light emitting element of the light source 10 so as to reproduce the third wavelength sequentially calculated by the first calculator 110. Note that the light source 10 is assumed to have two or more types of light emitting elements having different spectral distributions. In addition, the emission intensities of the light emitting elements can be individually controlled. The light emitting elements are light emitting diodes (LEDs) corresponding to three primary colors of R (red), G (green) and B (blue), for example. Since the LEDs are small and lightweight, it is relatively easy to mount a plurality of LEDs in one lighting apparatus and control the emission intensity of each LED independently. When the spectral distribution of each LED is represented by Pᵢ(λ) and the emission intensity of each LED is represented by aᵢ, the spectral distribution P(λ) of the whole lighting apparatus in which n types of LEDs having different spectral distributions are mounted can be expressed by Equation (4).

P(λ)=Σᵢ₌₁ⁿaᵢ·Pᵢ(λ), (1≦i≦n) (4)

Thus, the spectral distribution of the light source 10 can be considered as being determined by the emission intensities a, of n LEDs. Note that any number of light emitting elements may be used and white LEDs with different color temperatures may be used as the light emitting elements.

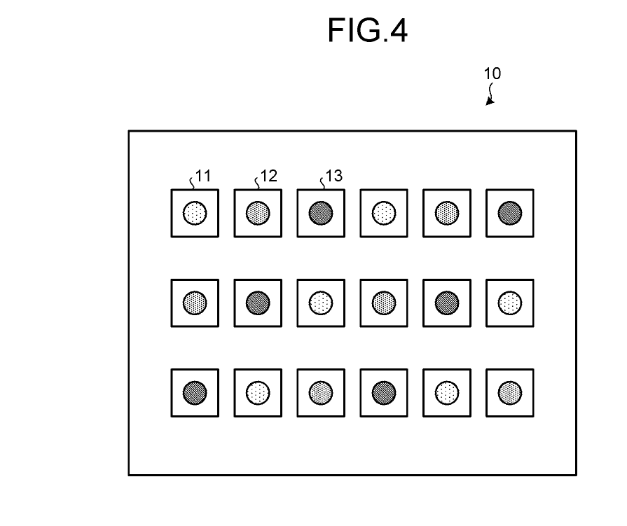

FIG. 4 is a diagram illustrating exemplary arrangement of the light emitting elements of the light source 10. As illustrated in FIG. 4, light emitting elements including light emitting elements 11, light emitting elements 12 and light emitting elements 13 that are different types of chip LEDs are arranged in the light source 10. In the example of FIG. 4, color mixture of lights from the light emitting elements 11, the light emitting elements 12 and the light emitting elements 13 is emitted as light by the light source 10. The light emitting elements may be any of fluorescent tubes, incandescent light bulbs and sodium lamps in addition to LEDs, or may be a combination thereof. Furthermore, the light source 10 may further include a light diffuser for color mixture of lights from a plurality of light emitting elements.

Examples of techniques for controlling emission of the light emitting elements of the light source 10 include a technique of controlling the amounts of current flowing through the light emitting elements and a technique of controlling the voltages to be applied to the light emitting elements. Control of the current and the voltage may be made in direct current or in alternating current. The control method may be in any form such as pulse width modulation (PWM) control or phase control.

The second calculator 120 holds the values of spectral distributions of the light emitting elements included in the light source 10, and calculates the emission intensities aᵢ by Equation (4). The method for calculating the emission intensities aᵢ may be to solve an optimization problem with constraint condition, and examples of an optimization method include the gradient method and the simulated annealing method. The second calculator 120 obtains the emission intensities aᵢ that satisfy the condition of 1≦i≦n by using these method. The emission intensities aᵢ calculated by the second calculator 120 are output to the light source 10. As a result, in the light source 10, the emission of the light emitting elements are controlled according to the emission intensities aᵢ calculated by the second calculator 120. When the second wavelength and the third wavelength become equal to each other, the emission intensities at this time are maintained until the illumination is turned off.

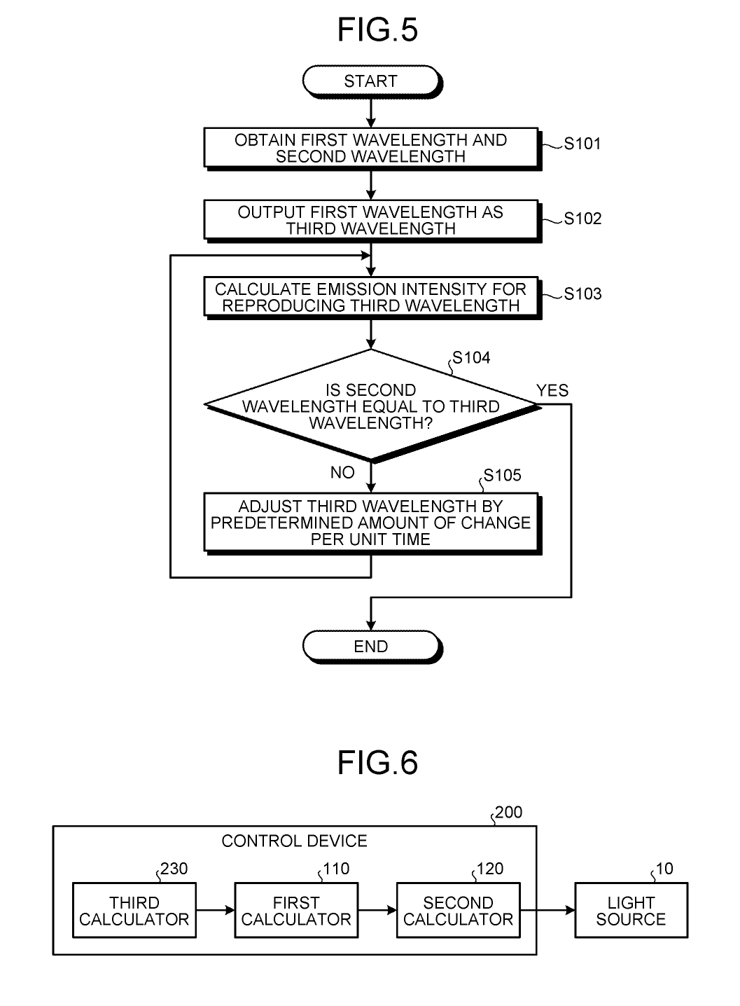

Next, a flow of overall processing according to the first embodiment will be described with reference to FIG. 5. FIG. 5 is a flowchart illustrating an example of a flow of an overall process according to the first embodiment.

As illustrated in FIG. 5, the first calculator 110 obtains the first wavelength and the second wavelength from a predetermined memory (step S101). The first calculator 110 then outputs the obtained first wavelength that is an initial wavelength as the third wavelength to the second calculator 120 (step S102).

The second calculator 120 calculates the emission intensity of each light emitting element of the light source 10 for reproducing the third wavelength output from the first calculator 110 (step S103). Here, the emission intensity of each light emitting element calculated by the second calculator 120 is output to the light source 10, and the light source 10 controls the emission of each light emitting element according to the emission intensity.

The first calculator 110 also determines whether or not the calculated third wavelength and the obtained second wavelength are equal (step S104). If it is determined that the third wavelength and the second wavelength are not equal (step S104: No), the first calculator 110 adjusts and updates the third wavelength by the predetermined amount of change per unit time (step S105). If, on the other hand, it is determined that the third wavelength and the second wavelength are equal (step S104: Yes), the first calculator 110 terminates the process.

Thus, the processing of calculating the emission intensity of each light emitting element so as to reproduce the third wavelength by the second calculator 120 according to the third wavelength sequentially updated by the first calculator 110 is repeated until the second wavelength of the color desired by the user and the sequentially updated third wavelength become equal.

According to the present embodiment, the spectral distribution of a color of illumination that is less uncomfortable for the user is used at the start of illumination, and the spectral distribution is updated at such a speed that a change in the color of the illumination is not perceived by the user until the spectral distribution of the color of illumination desired by the user is obtained. As a result, it is possible to output light of a desired color without making the user uncomfortable.

### Second Embodiment

FIG. 6 is a block diagram illustrating an exemplary configuration of a control device 200 according to a second embodiment. In the second embodiment, components similar to those in the first embodiment will be designated by the same reference numerals and detailed description thereof may not be repeated. The second embodiment is the same as the first embodiment in the functions, components and processing other than those of a third calculator 230 to be described below.

As illustrated in FIG. 6, the control device 200 includes the first calculator 110, the second calculator 120 and the third calculator 230. The control device 200 is connected to the light source 10 whose emission intensity is controllable and which has at least one light emitting element. Similarly to the first embodiment, the control device 200 is a device that adjusts the color of output light output from the light source 10.

The third calculator 230 calculates a non-visual effect level representing the degree of influence of the output light from the light source 10 on the user other than the sight of the user when the first wavelength is changed to the third wavelength. The third calculator 230 then calculates the second wavelength corresponding to the color desired by the user according to a set value (user setting) representing the degree of the non-visual effect level, and outputs the calculated second wavelength to the first calculator 110. Such user settings are stored in a predetermined memory in advance by using a remote controller or the like. The first calculator 110 then calculates the third wavelength from the second wavelength output from the third calculator 230 and the first wavelength obtained from the predetermined memory.

The non-visual effect level is calculated by integration of a product of a melatonin secretion inhibiting action spectrum and the spectral distribution of the illumination, for example. Alternatively, the non-visual effect level may be a value of a prediction formula for melatonin secretion inhibition taking responses of cones, rods and ganglion cells containing melanopsin into account. When the prediction formula for melatonin secretion inhibition is used, the non-visual effect level I₁ is defined by Equation (5).

I₀=visP(λ)·M₁(λ)dλ (5)

In Equation (5), P(λ) represents the spectral distribution of the illumination and M₁(λ) represents the melatonin secretion inhibiting spectrum. When the non-visual effect level I₁ is calculated by the prediction formula for melatonin secretion inhibition, the formula varies depending on the values of TH expressed by Equation (6). If TH≧0, then the non-visual effect level I₁ is calculated by Equation (7), while if TH<0, then the non-visual effect level I₁ is calculated by Equation (8).

$$\begin{matrix} TH = \int vis P ( λ ) \cdot S ( λ ) d λ - j \int vis P ( λ ) \cdot {V}_{10} ( λ ) d λ & ( 6 ) \\ {I}_{1} = ⌊ ( {β}_{1} \int vis P ( λ ) \cdot {M}_{2} ( λ ) d λ - {b}_{1} ) + {β}_{2} ( \int vis P ( λ ) \cdot S ( λ ) d λ - j \int vis P ( λ ) \cdot {V}_{10} ( λ ) d λ ) - {b}_{2} ] - {β}_{3} [ 1 - exp ( - \frac{\int vis P ( λ ) \cdot {V}^{′} ( λ ) d λ}{rodSat} ) ] & ( 7 ) \\ {I}_{1} = {β}_{1} \int vis P ( λ ) \cdot {M}_{2} ( λ ) d λ - {b}_{1} & ( 8 )\end{matrix}$$

In the equations, constants are as follows: j=0.31, β₁=0.285, β₂=0.2, β₃=0.72, b₁=0.01, b₂=0.001, and rodSat=6.5. In addition, M₂(λ) represents the spectral reaction sensitivity of ganglion cells containing melanopsin. V₁₀(λ) represents the spectral reaction sensitivity of L-cones and M-cones. V′(λ) represents the spectral reaction sensitivity of rods. S(λ) represents the spectral reaction sensitivity of S-cones. As a result, the non-visual effect level I₁ is calculated.

The user settings are made so that the non-visual effect level is maximum when the user desires to be awake and that the non-visual effect level is minimum when the user does not desire to be awake, which is effective before falling asleep or the like. The user settings can also be made to set an arbitrary degree of non-visual effect level desired by the user in addition to maximum and minimum degrees. Specifically, the second wavelength can change the spectrum of the first wavelength so that the non-visual effect level calculated by using Equation (6) to Equation (8) becomes a value according to the user settings.

As an example of changing the non-visual effect level that determines the second wavelength by user settings, when a value set by the user so that a spectrum that maximizes the non-visual effect level is the second wavelength is −1.0, a value set by the user so that a spectrum equal to that of the first wavelength is the second wavelength is 0.0, and a value set by the user so that a spectrum that minimizes the non-visual effect level is the second wavelength is 1.0, the operation for setting is preferably intuitive by using a user interface allowing the user to set a continuous value between −1.0 and 1.0. For example, when the value set by the user is γ, the non-visual effect level of a spectrum that is set to the second wavelength is calculated according to Equation (9). In Equation (9), I₁_{ₛ} represents the non-visual effect level calculated from the first wavelength. I₁_{_{t-Max}} represents the maximum non-visual effect level. I₁_{ₜ₋ₘᵢₙ} represents the minimum non-visual effect level. I₁′ represents the non-visual effect level determined according to the user settings.

$${I}_{1}^{′} = \{ \begin{matrix}if γ \geq 0.0 & ( 1.0 - γ ) \cdot {I}_{{1}_{s}} + γ \cdot {I}_{{1}_{t - Max}} \\ else & ( 1.0 - γ ) \cdot {I}_{{1}_{s}} + γ \cdot {I}_{{1}_{t - min}}\end{matrix} \qquad ( 9 )$$

In this case, the spectrum of the first wavelength is changed so that the spectral distribution of the illumination satisfies a certain condition. As the condition for changing the spectrum, Equation (10) that is a condition that the sum of products of spectral distribution in the visible light region becomes constant or Equation (11) that is a condition that the sum of squares of the spectral distribution in the visible light region becomes constant may be used. Alternatively, Equation (12) that is a condition that a product of the spectral distribution and the spectral luminous efficiency V(λ) becomes constant may be used so that the brightness of the illumination seems to be constant.

cons tan t=∫visP(λ)dλ (10)

cons tan t=∫visP(λ)·P(λ)dλ (11)

cons tan t=∫visP(λ)·V(λ)dλ (12)

The second wavelength is calculated by changing the spectrum of the first wavelength so that the non-visual effect level calculated by Equation (6) to Equation (8) to satisfy the conditions of Equation (10) to Equation (12) is according to user settings. In the calculation of the second wavelength, an optimization problem with constraint condition may be solved, and an optimization method such as the gradient method and the simulated annealing method may be used. In general, the spectral distribution with which the non-visual effect level is maximum is a bluish spectral distribution containing many wavelength components around 460 nm. In addition, the spectral distribution with which the non-visual effect is maximum is an yellowish spectral distribution without containing wavelength components around 460 nm. Note that a non-visual effect level calculated in advance according to user settings may be used.

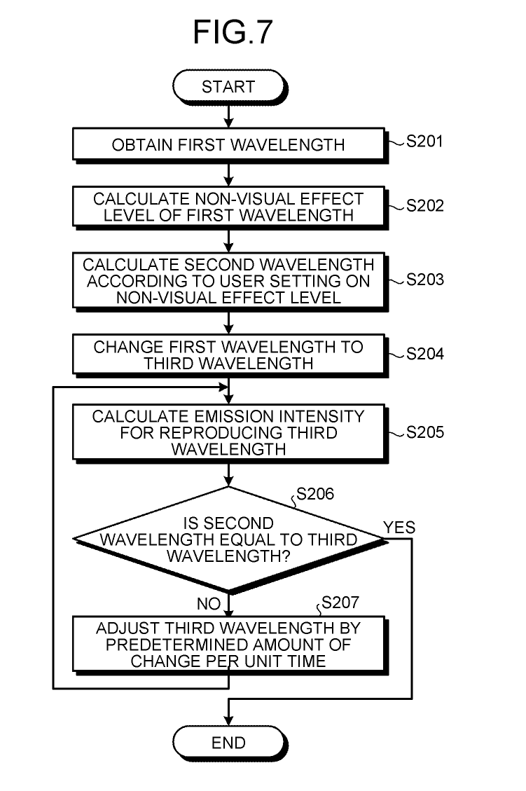

Next, a flow of overall processing according to the second embodiment will be described with reference to FIG. 7. FIG. 7 is a flowchart illustrating an example of a flow of an overall process according to the second embodiment. In FIG. 7, description of the process that is the same as the overall process according to the first embodiment may not be repeated. Specifically, the processes in steps S204 to S207 is the same as those in steps S102 to S105.

As illustrated in FIG. 7, the third calculator 230 obtains the first wavelength from a predetermined memory (step S201). The third calculator 230 then calculates the non-visual effect level with the obtained first wavelength (step S202). Subsequently, the third calculator 230 calculates the second wavelength according to user settings representing the degree of non-visual effect level (step S203). Thereafter, the process of calculating the emission intensity of each light emitting element for reproducing the third wavelength by the second calculator 120 according to the third wavelength sequentially updated by the first calculator 110 is repeated until the second wavelength according to user settings of the non-visual effect level and the sequentially updated third wavelength become equal.

According to the present embodiment, the spectral distribution of a color of illumination that is less uncomfortable for the user is used at the start of illumination, and the spectral distribution is updated at such a speed that a change in the color of the illumination is not perceived by the user until the spectral distribution of the color of illumination according to settings of the non-visual effect level desired by the user is obtained. As a result, it is possible to output light of desired color producing an effect of improving the level of arousal or an effect of lowering the level of arousal without making the user feel uncomfortable.

### Third Embodiment

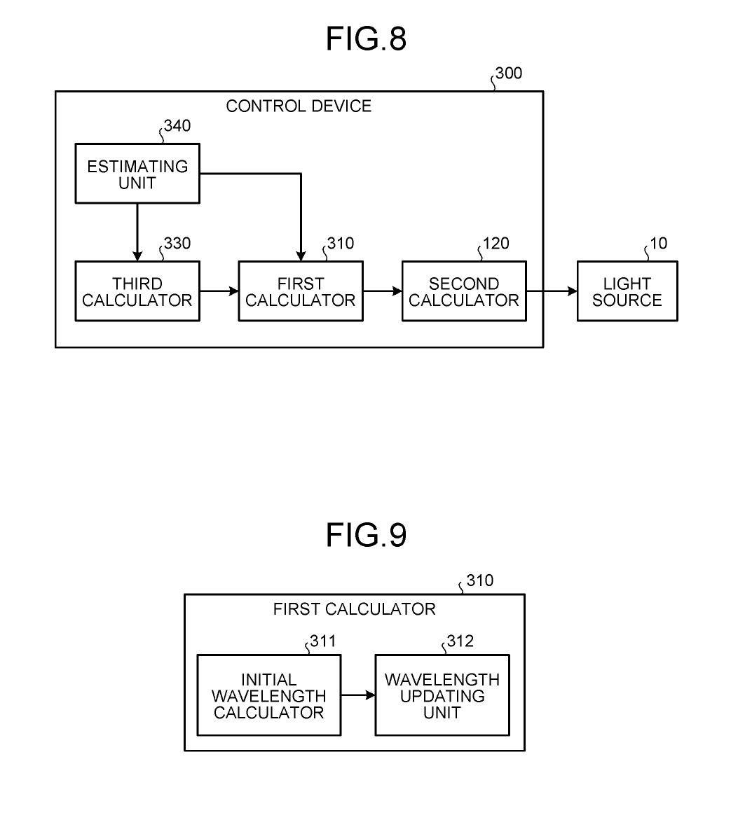

FIG. 8 is a block diagram illustrating an exemplary configuration of a control device 300 according to a third embodiment. In the third embodiment, components similar to those in the first embodiment will be designated by the same reference numerals and detailed description thereof may not be repeated. The third embodiment is the same as the first embodiment in the functions, components and processing other than those of a first calculator 310, a third calculator 330 and an estimating unit 340 to be described below.

As illustrated in FIG. 8, the control device 300 includes the first calculator 310, the second calculator 120, the third calculator 330, and the estimating unit 340. The control device 300 is connected to the light source 10 whose emission intensity is controllable and which has at least one light emitting element. Similarly to the first embodiment, the control device 300 is a device that adjusts the color of output light output from the light source 10.

The estimating unit 340 holds the current time, and determines either one of a first mode corresponding to daytime and a second mode corresponding to night on the basis of the current time. The estimating unit 340 also records the time when illumination by the light source 10 is started and the time when the light source 10 is turned off to estimate the bedtime of the user on the day.

The daytime zone is a time zone from six in the morning to six in the afternoon, for example. The night zone is a time zone from six in the afternoon to six in the morning. These time zones may be arbitrarily set according to lifestyle of the user. As a method for estimating the bedtime, there is a method of adding up the time when illumination is turned off for each day of the week and averaging the addition result to obtain the bedtime. Examples of other methods include synchronizing with the schedule of the user and estimating the bedtime from the schedule of going to bed, or estimating the bedtime from the schedule of getting up. These methods may be used in combination.

The third calculator 330 determines the spectral distribution with which the non-visual effect level is maximum or minimum as the second wavelength according to the mode determined by the estimating unit 340. In more detail, if the mode is determined to be the first mode by the estimating unit 340, the third calculator 330 determines the spectral distribution with which the non-visual effect level is maximum as the second wavelength. If, on the other hand, the mode is determined to be the second mode by the estimating unit 340, the third calculator 330 determines the spectral distribution with which the non-visual effect level is minimum as the second wavelength.

Thus, the second wavelength is determined as the spectral distribution with which the non-visual effect level is maximum in the first mode corresponding to the daytime time zone so as to make the level of arousal higher, or as the spectral distribution with which the non-visual effect level is minimum in the second mode corresponding to the night time zone so as to make the level of arousal lower. Note that the non-visual effect level may be a first threshold near the maximum value thereof or higher or may be a second threshold near the minimum value thereof or lower instead of the maximum value or the minimum value thereof. The first threshold and the second threshold can preferably be adjusted according to a value γ of the user settings. Note that the relation between the first threshold and the second threshold is (first threshold)>(second threshold).

Next, the first calculator 310 will be described. FIG. 9 is a block diagram illustrating an exemplary configuration of the first calculator 310 according to the third embodiment. As illustrated in FIG. 9, the first calculator 310 includes an initial wavelength calculator 311 and a wavelength updating unit 312. The initial wavelength calculator 311 calculates an initial wavelength representing the wavelength at the start of adjustment so that adjustment will end by the bedtime from the first wavelength, the second wavelength, the current time and the bedtime. The wavelength updating unit 312 sequentially updates the third wavelength by calculating the third wavelength adjusted by a predetermined amount of change per unit time within a range from the initial wavelength calculated by the initial wavelength calculator 311 to the second wavelength determined by the third calculator 330. When the second wavelength and the third wavelength become equal, the light of the color desired by the user is output from the illumination until the mode is updated or the illumination is turned off.

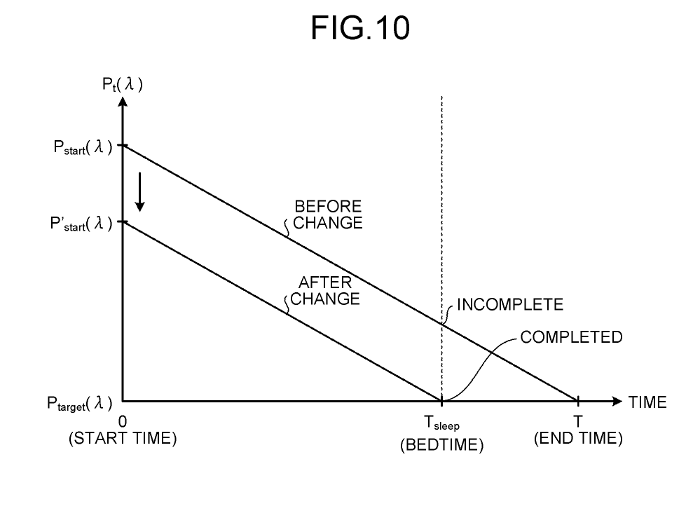

FIG. 10 is a graph illustrating an example of changing the initial wavelength according to the bedtime according to the third embodiment. The time T [s] until the end of adjustment can be obtained from the initial wavelength and the predetermined amount of change, but there is a possibility that the time obtained by adding T [s] to the current time is later than the bedtime. As illustrated in FIG. 10, when the initial wavelength before being changed, that is, the first wavelength is used as the initial wavelength Pₛₜₐᵣₜ(λ), the time T at which adjustment ends exceeds the bedtime Tₛₗₑₑₚ and the adjustment will thus be incomplete without reaching the second waveform P_{target}(λ). Therefore, since it is preferable to end the adjustment by the bedtime, the initial wavelength is changed according to the bedtime. When the initial wavelength P′ₛₜₐᵣₜ(λ) after being changed is used, the adjustment is completed by the bedtime Tₛₗₑₑₚ and the second wavelength P_{target}(λ) is reached. While the initial wavelength is changed so that the bedtime agrees with the end of adjustment in the example of FIG. 10, it is sufficient that the adjustment ends by the bedtime.

For example, when the initial wavelength is changed so that the third wavelength becomes equal to the second wavelength at the bedtime, the changed initial wavelength P′ₛₜₐᵣₜ(λ) can be expressed by Equation (13).

$${P}_{start}^{′} ( λ ) = ( 1 - \frac{T - {T}_{sleep}}{T} ) {P}_{start} ( λ ) + \frac{T - {T}_{sleep}}{T} {P}_{target} ( λ ) \qquad ( 13 )$$

In Equation (13), Tₛₗₑₑₚ represents the time from the current time until the bedtime. In addition, Pₛₜₐᵣₜ(λ) represents the initial wavelength before being changed, that is, the first wavelength. P_{target}(λ) represents the second wavelength. The initial wavelength calculated in this manner is output to the wavelength updating unit 312. Then, the wavelength updating unit 312 sequentially calculates the third wavelength that is adjusted by the predetermined amount of change per unit time within a range from the initial wavelength to the second wavelength. When the mode is changed as a result of elapse of time, however, the second wavelength is changed and the processing is performed. Note that the method for calculating the initial wavelength and the predetermined amount of change when the bedtime is not taken into account is the same as that in the first embodiment.

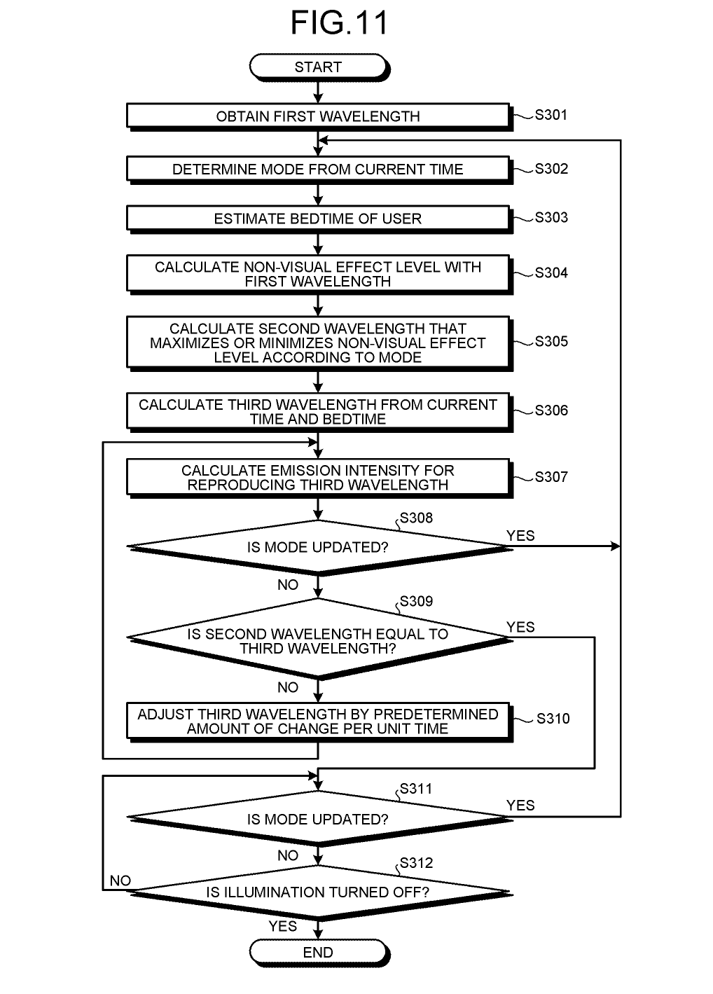

Next, a flow of an overall process according to the third embodiment will be described with reference to FIG. 11. FIG. 11 is a flowchart illustrating an example of a flow of the overall process according to the third embodiment.

As illustrated in FIG. 11, the third calculator 330 obtains the first wavelength from a predetermined memory (step S301). In addition, the estimating unit 340 determines either of the first mode or the second mode on the basis of the current time (step S302). The estimating unit 340 then estimates the bedtime of the user on the day from the bedtime or the like of the user that is recorded in advance (step S303).

The third calculator 330 then calculates the non-visual effect level with the obtained first wavelength (step S304). The third calculator 330 then calculates the second wavelength with which the non-visual effect level is maximum or minimum according to the mode determined by the estimating unit 340 (step S305). The first calculator 310 obtains the first wavelength from the predetermined memory, receives the second wavelength calculated by the third calculator 330 and further receives the current time and the estimated bedtime from the estimating unit 340. The first calculator 310 then calculates the third wavelength as the initial wavelength from the first wavelength, the second wavelength, the current time and the bedtime (step S306).

The second calculator 120 calculates the emission intensity of each light emitting element of the light source 10 so as to reproduce the third wavelength calculated by the first calculator 310 (step S307). Here, the emission intensity of each light emitting element calculated by the second calculator 120 is output to the light source 10, and the light source 10 controls the emission of each light emitting element according to the emission intensity. The estimating unit 340 determines whether the mode is updated (step S308).

If it is determined that the mode is updated (step S308: Yes), the processing of step S302 is repeated and the second wavelength is changed. If, on the other hand, it is determined that the mode is not updated (step S308: No), the first calculator 310 determines whether or not the calculated third wavelength and the second wavelength calculated by the third calculator 330 are equal (step S309). If it is determined that the third wavelength and the second wavelength are not equal (step S309: No), the first calculator 310 adjusts and updates the third wavelength by the predetermined amount of change per unit time (step S310). If, on the other hand, the first calculator 310 determines that the third wavelength and the second wavelength are equal (step S309: Yes), the estimating unit 340 determines whether or not the mode is updated (step S311).

If it is determined that the mode is updated (step S311: Yes), the processing of step S302 is repeated and the second wavelength is changed. If, on the other hand, it is determined that the mode is not updated (step S311: No), it is determined whether the illumination is turned off (step S312). If it is determined that the illumination is on (step S312: No), the processing of step S311 is repeated and it is determined by the estimating unit 340 whether or not the mode is updated (step S311). If, on the other hand, it is determined that the illumination is off (step S312: Yes), the processing is terminated. For determining whether the illumination is on or off, the state of a switch (the remote controller 20 or the like) of the light source 10 may be checked and information of such a state is acquired from the remote controller 20 or the like.

According to the present embodiment, the spectral distribution of a color of illumination that is less uncomfortable for the user is used at the start of illumination, and the spectral distribution is updated at such a speed that a change in the color of the illumination is not perceived by the user until the spectral distribution of the color of illumination with which the non-visual effect level becomes maximum or minimum according to the current time and the bedtime is obtained. As a result, effects that light of a desired color is output without making the user feel uncomfortable, that the level of arousal is kept high in the daytime to improve the work efficiency and that the level of arousal is lowered at night so that learned content or the like is stored in the brain for a long time during sleep.

### Fourth Embodiment

While embodiments of the control device have been described, the control device may be embodied in various different forms in addition to the embodiments described above. Different embodiments will therefore be described with respect to (1) determination of initial wavelength, (2) determination of third wavelength, (3) calculation of emission intensity, (4) setting of bedtime, (5) change of initial wavelength, (6) illumination device, and (7) configuration.

### (1) Determination of Initial Wavelength

In the first embodiment described above, a case in which the first wavelength that does not make the user uncomfortable is used as the initial wavelength to be applied at the start of color adjustment (at the start of illumination) has been described, but the degree of discomfort that is tolerated may be specified by the user. For example, the degree of discomfort that is tolerated is represented by αₛₜₐᵣₜ, and the user is made to specify αₛₜₐᵣₜ within a range of 0 to 1.0 to change the initial wavelength. In this case, the changed initial wavelength Pₛₜₐᵣₜ(λ) is expressed by Equation (14).

Pₛₜₐᵣₜ(λ)=(1−αₛₜₐᵣₜ)P_{base}(λ)+αₛₜₐᵣₜP_{target}(λ) (14)

In Equation (14), P_{base}(λ) represents the first wavelength and P_{target}(λ) represents the second wavelength. Specifically, when αₛₜₐᵣₜ=0, Pₛₜₐᵣₜ(λ)=P_{base}(λ) is obtained, and the discomfort when the illumination is turned on is minimum. When αₛₜₐᵣₜ=1.0, Pₛₜₐᵣₜ (λ)=P_{target}(λ) is obtained, and the discomfort when the illumination is turned on is maximum. Note that the degree of discomfort αₛₜₐᵣₜ that is tolerated can be selected by the user by using a sliding bar or buttons for quantized levels provided on the control device 100, an attached remote controller or the like. As a result, illumination with the color desired by the user can be achieved in a shorter time.

### (2) Determination of Third Wavelength

In the first embodiment described above, the third wavelength is determined by calculating the spectral distribution Pₜ(λ) from a color difference ΔE*_{ab}_{ₛ₋ₜ} between the color of an object at the start of adjustment and the color of the object at the end of adjustment and the predetermined amount of change V, but the third wavelength may be determined by other methods. For example, the spectral distribution may be updated so that the color difference when the third wavelength is updated is always constant. In such a case, the spectral distribution Pₜ(λ) t seconds after the start of adjustment is expressed by Equation (15).

Pₜ(λ)=(1−β(t))Pₛₜₐᵣₜ(λ)+β(t)P_{target}(λ) (15)

In Equation (15), β(t) is a function that α-blends the initial wavelength Pₛₜₐᵣₜ(λ) and the second wavelength P_{target}(λ) and outputs a value of 0 to 1.0 having the wavelength update time t as an argument. When the interval at which the third wavelength is updated is represented by Δt [s], the time when the third wavelength is updated previously is t−Δt [s]. Here, a color difference between the color (L*ₜ, a*ₜ, b*ₜ) of an object illuminated with the spectral distribution Pₜ(λ) t seconds after the start of adjustment and the color (L*_{t-Δt}, a*_{t-Δt}, b*_{t-Δt}) of the object illuminated by the spectral distribution P_{t-Δt}(λ) (t−Δt) seconds after the start of adjustment is represented by ΔE*_{ab}_{ₜ}. It is then possible to keep constant color difference when the third wavelength is updated by calculating β(t) when the third wavelength is updated so that the color difference ΔE*_{ab}_{ₜ} is constant and determining Pₜ(λ). In other words, when the color difference is represented by ΔE*_{ab}=V and the interval at which the third wavelength is updated is represented by Δt regarding the predetermined amount of change, Pₜ(λ) is determined by obtaining β(t) with which ΔE*_{ab}_{ₜ}=VΔt is satisfied when the third wavelength is updated.

### (3) Calculation of Emission Intensity

In the first embodiment described above, a case in which the emission intensity of each light emitting element to reproduce the third wavelength is sequentially calculated has been described, the emission intensity of each light emitting element may be sequentially calculated without calculating the third wavelength. First, the color (L*ₛₜₐᵣₜ, a*ₛₜₐᵣₜ, b*ₛₜₐᵣₜ) of an object illuminated with the initial wavelength Pₛₜₐᵣₜ(λ) and the color (L*_{target}, a*_{target}, b*_{target}) of the object illuminated with the second wavelength P_{target}(λ) are calculated. Accordingly, a change ΔE*_{ab}_{ₛ₋ₜ}/V in the color of the object between the start of adjustment and the end of adjustment is obtained. In addition, regarding the predetermined amount of change, T [s] that satisfies T=ΔE*_{ab}_{ₛ₋ₜ}/V where the color difference is represented by ΔE*_{ab}=V is obtained. T [s] represents time required from the start of adjustment to the end of adjustment.

Next, the emission intensity aₛₜₐᵣₜ_{ᵢ} (1≦i≦n) of each light emitting element for reproducing the initial wavelength Pₛₜₐᵣₜ(λ) and the emission intensity a_{target}_{ᵢ} (1≦i≦n) of each light emitting element for reproducing the second wavelength P_{target}(λ) are obtained. As a result, the emission intensity “aₜᵢ (1≦i≦n) of light emitted by each light emitting element t seconds after the start of adjustment can be expressed by Equation (16). The spectral distribution of the light source 10 is changed by sequentially updating the emission intensity aₜᵢ by using Equation (16).

$${a}_{ti} ( λ ) = ( 1 - \frac{t}{T} ) {a}_{{start}_{i}} + ( \frac{t}{T} ) {a}_{{target}_{i}} ( λ ) , ( 1 \leq i \leq n ) \qquad ( 16 )$$

### (4) Setting of Bedtime

In the third embodiment described above, a case in which the bedtime on the day is estimated on the basis of past bedtimes or the like has been described, but the bedtime on the day may be set by the user. The user directly inputs the bedtime or selects one from a plurality of candidates of bedtime that are presented. For presenting a plurality of candidates of the bedtime, an interface capable of specifying the bedtime estimated from records of every-day bedtime or time around the bedtime is used.

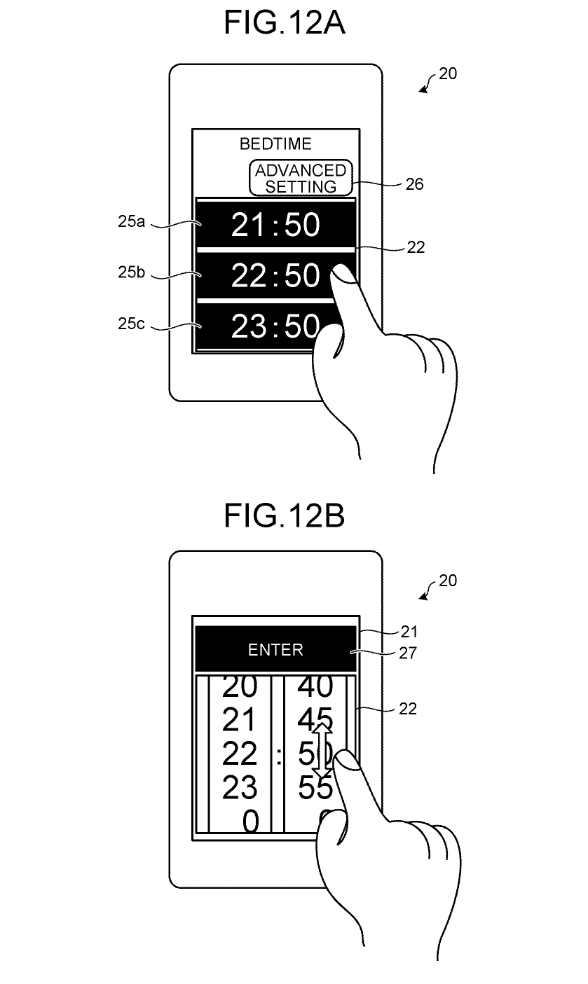

FIGS. 12A and 12B are diagrams illustrating examples of the interface for allowing the user to set the bedtime. As illustrated in FIG. 12A, the remote controller 20 is equipped with a screen 21 such as a touch panel display. The screen 21 has a display area 22 that can be scrolled by flicking and in which an item can be selected by tapping. In this display area 22, candidates of the bedtime estimated on the basis of records of every-day bedtime are displayed.

For example, a candidate 25a is “21:50”, a candidate 25b is “22:50”, and a candidate 25c is “23:50”. When an advanced setting button 26 is pressed after a candidate is selected, time around the selected candidate can be specified as illustrated in FIG. 12B. In the example of FIG. 12B, since the candidate 25b is selected, time around “22:50” can be specified. The user scrolls the display area 22 that can be flicked or tapped and presses an enter button 27 on the screen 21 of the remote controller 20. As a result, the bedtime is set.

### (5) Change of Initial Wavelength

In the third embodiment described above, a case in which the initial wavelength at the start of adjustment is changed so that the adjustment will end by the bedtime has been described, but the initial wavelength may be changed when the non-visual effect level on the user until the user goes to bed exceeds a predetermined threshold. The non-visual effect level I_{SUM} on the user until the user goes to bed is expressed by Equation (17). Then, when the calculated non-visual effect level I_{SUM} exceeds a predetermined threshold of the non-visual effect level, the initial wavelength is changed by using Equation (18).

$$\begin{matrix}{I}_{SUM} = {\int }_{t = {t}_{0}}^{t = {t}_{sleep}} \int vis ( ( 1 - \frac{t}{T} ) {P}_{start} ( λ ) + ( \frac{t}{T} ) {P}_{target} ( λ ) ) \cdot {M}_{1} ( λ ) d λ d t & ( 17 ) \\ {P}_{start}^{′} ( λ ) = ( 1 - \frac{T - {T}_{ADJ}}{T} ) {P}_{start} ( λ ) + \frac{T - {T}_{ADJ}}{T} {P}_{target} ( λ ) & ( 18 )\end{matrix}$$

Equation (17) is an equation that calculates the non-visual effect level on the user until the user goes to bed from the prediction formula for melatonin secretion inhibition of Equation (5) when the spectral distribution of the illumination is sequentially updated by using the third wavelength determined by Equation (3). In Equation (18), T_{ADJ} represents a coefficient for changing the initial wavelength. Then, the initial wavelength is changed by increasing the value of T_{ADJ} until the non-visual effect level I_{SUM} becomes lower than the predetermined threshold.

### (6) Illumination Device

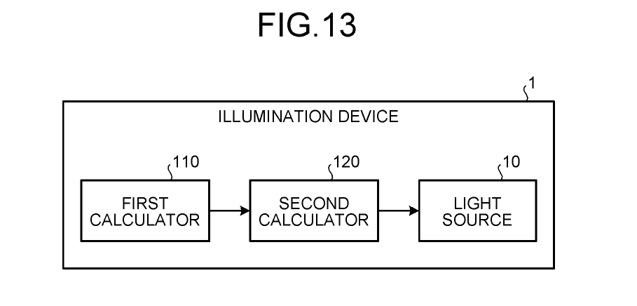

In the embodiments described above, the control device that adjusts the color of output light output from the light source 10 has been described, but an embodiment as an illumination device including the control device and the light source 10 may be provided. FIG. 13 is a block diagram illustrating an exemplary configuration of an embodiment as an illumination device 1. As illustrated in FIG. 13, the illumination device 1 includes the first calculator 110, the second calculator 120, and the light source 10. Since processing performed by each block of the illumination device 1 is the same as that in the embodiments described above, description thereof will not be repeated.

### (7) Configuration

The procedures of processing, the procedures of control, the information including specific names, various data and parameters presented in the specification and in the drawings can be arbitrarily modified unless otherwise stated. The components of the control device that are illustrated are functional and conceptual, and need not necessarily be physically configured as illustrated. In other words, specific forms of distribution and integration of devices are not limited to those illustrated but the whole or part thereof can be functionally or physically distributed or integrated in any units according to various loads and use. For example, the estimating unit 340 may be divided into a determining unit that determines either one of the first mode or the second mode on the basis of the current time and an estimating unit that estimates the bedtime of the user.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A control device comprising:
a first calculator configured to calculate a wavelength of light to be emitted from a light source whose emission intensity is controllable and which has at least one light emitting element at predetermined time intervals in a manner that adjusts the wavelength by a predetermined amount of change within a range of a first wavelength of light to be emitted at a start of adjustment to a second wavelength of light to be emitted at an end of the adjustment, the calculated wavelength being set as a third wavelength; and
a second calculator configured to calculate an emission intensity of the light emitting element for reproducing the third wavelength.

2. The control device according to claim 1, further comprising a third calculator configured to
calculate a non-visual effect level representing a degree of effect with the first wavelength other than an effect on sight, and
calculate the second wavelength on the basis of a set value of the calculated non-visual effect level.

3. The control device according to claim 1, further comprising:
an estimating unit configured to determine whether the current mode is a first mode representing a mode for daytime or a second mode representing a mode for night; and
a third calculator configured to
calculate a non-visual effect level representing a degree of effect with the first wavelength other than an effect on sight,
calculate the second wavelength as a wavelength with which the non-visual effect level becomes a first threshold or higher in the first mode, and
calculate the second wavelength as a wavelength with which the non-visual effect level becomes a second threshold or lower in the second mode, the second threshold being smaller than the first threshold.

4. The control device according to claim 1, wherein the first calculator calculates an initial wavelength by changing the first wavelength on the basis of current time and bedtime so that the adjustment ends by the bedtime, and calculates the third wavelength that is adjusted by the predetermined amount of change at the predetermined time intervals within a range of the calculated initial wavelength to the second wavelength.

5. The control device according to claim 4, further comprising an estimating unit configured to estimate bedtime of the current day from bedtimes of multiple days, wherein
the first calculator calculates the initial wavelength by changing the first wavelength on the basis of the current time and the estimated bedtime so that the adjustment will end by the estimated bedtime.

6. The control device according to claim 3, wherein the first calculator calculates an initial wavelength by changing the first wavelength so that the non-visual effect level becomes lower when the non-visual effect level until the bedtime exceeds a predetermined threshold, and calculates the third wavelength that is adjusted by the predetermined amount of change at the predetermined time intervals within a range of the calculated initial wavelength to the second wavelength.

7. The control device according to claim 1, wherein the first calculator adjusts the third wavelength by the predetermined amount of change such that a color difference in a uniform color space of an object illuminated by the light emitted from the light source is constant to calculate the third wavelength.

8. The control device according to claim 1, wherein, for the predetermined amount of change, a color difference calculated from a given color space is utilized.

9. The control device according to claim 2, wherein the non-visual effect level is calculated in accordance with a set value selected by a user to be between a value for which a wavelength that maximizes the non-visual effect level is the second wavelength and a value for which a wavelength that minimizes the non-visual effect level is the second wavelength.

10. The control device according to claim 2, wherein the non-visual effect level is calculated by using a prediction formula for melatonin secretion inhibition and a spectral distribution of an illumination.

11. The control device according to claim 2, wherein the non-visual effect level is calculated by integration of a product of a melatonin secretion inhibiting action spectrum and a spectral distribution of an illumination.

12. The control device according to claim 1, wherein, when a color difference in an L*a*b* color space is used, an adjustment is made by the predetermined amount of change that is a value less than 0.433 per unit time of one second or shorter.

13. An illumination device comprising:
a light source whose emission intensity is controllable and which has at least one light emitting element;
a first calculator configured to calculate a wavelength of light to be emitted from the light source at predetermined time intervals in a manner that adjusts the wavelength by a predetermined amount of change within a range of a first wavelength of light to be emitted at a start of adjustment to a second wavelength of light to be emitted at an end of the adjustment, the calculated wavelength being set as a third wavelength; and
a second calculator configured to calculate an emission intensity of the light emitting element for reproducing the third wavelength.
